(19) United States
(12) Patent Application Publication
(10) Pub. No.: US 2026/0364719 A1
(43) Pub. Date: Nov. 19, 2026

(54) LASER DRILLING CALIBRATION METHOD, LASER DRILLING CALIBRATION SYSTEM AND CALIBRATION PIECE

(71) Applicant: Prosemi Co., LTD., Tainan City (TW)

(72) Inventor: Shih-Tsung Tsai, Tainan City (TW)

(73) Assignee: Prosemi Co., LTD., Tainan City (TW)

(21) Appl. No.: 19/251,856

(22) Filed: Jun. 27, 2025

(30) Foreign Application Priority Data
May 15, 2025 (TW) 114118183

(51) Int. Cl. B23K 26/382; B23K 26/03; B23K 26/082; B23K 26/402; B23K 101/40; B23K 103/00; G05B 19/19

(52) U.S. Cl. CPC B23K 26/382; B23K 26/032; B23K 26/082; B23K 26/402; G05B 19/19; B23K 2101/40; B23K 2103/56; G05B 2219/45139

(57) ABSTRACT

A laser drilling calibration method includes steps as follows. A calibration pattern is provided. The calibration pattern includes predetermined positions of a plurality of calibration holes, the predetermined positions of the plurality of calibration holes are disposed along a first direction and are spaced apart by a multiple of a first predetermined pitch, and are disposed along a second direction and are spaced apart by a multiple of a second predetermined pitch. A laser beam is controlled to form the plurality of calibration holes on a calibration piece according to the calibration pattern. A first standard pitch and a second standard pitch are selected on the calibration piece. An offset of at least one of the plurality of calibration holes is calculated according to the first standard pitch and the second standard pitch.

### BACKGROUND OF THE INVENTION

### 1. Field of the Invention

The present disclosure relates to a calibration method, a calibration system and a calibration piece, and more particularly, to a laser drilling calibration method, a laser drilling calibration system and a calibration piece for laser drilling.

### 2. Description of the Prior Art

Using lasers to form holes, such as through-silicon vias (TSV) and through-glass vias (TGV), is widely applied in many high-tech fields, such as semiconductor packaging, three-dimensional integrated circuit packaging (3D IC packaging), micro-electro-mechanical systems, optoelectronic devices, etc. With the ongoing trend of miniaturization in electronic devices, how to improve the accuracy of holes formed by the laser to improve the yield of electronic devices has become a goal of relevant industries.

### SUMMARY OF THE INVENTION

According to an embodiment of the present disclosure, a laser drilling calibration method includes steps as follows. A calibration pattern is provided. The calibration pattern includes predetermined positions of a plurality of calibration holes, the predetermined positions of the plurality of calibration holes are disposed along a first direction and are spaced apart by a multiple of a first predetermined pitch, and are disposed along a second direction and are spaced apart by a multiple of a second predetermined pitch. A laser beam is controlled to form the plurality of calibration holes on a calibration piece according to the calibration pattern. A first standard pitch and a second standard pitch are selected on the calibration piece. An offset of at least one of the plurality of calibration holes is calculated according to the first standard pitch and the second standard pitch.

According to another embodiment of the present disclosure, a calibration piece for laser drilling is provided. The calibration piece is defined with a device region and a non-device region disposed adjacently and includes two first standard patterns and two second standard patterns. The two first standard patterns are disposed in the non-device region. The two first standard patterns are arranged along a first direction and define a first standard pitch. The two second standard patterns are disposed in the non-device region. The two second standard patterns are arranged along a second direction and define a second standard pitch.

According to yet another embodiment of the present disclosure, a laser drilling calibration system includes a laser source, a beam adjustment unit and a control module. The laser source is for emitting a laser beam. The beam adjustment unit is for adjusting a direction of the laser beam. The control module is connected to the laser source and the beam adjustment unit. The control module is configured to: control the laser beam to form a plurality of calibration holes on a calibration piece according to a calibration pattern, wherein the calibration pattern includes predetermined positions of the plurality of calibration holes, the predetermined positions of the plurality of calibration holes are disposed along a first direction and are spaced apart by a multiple of a first predetermined pitch, and are disposed along a second direction and are spaced apart by a multiple of a second predetermined pitch; select a first standard pitch and a second standard pitch on the calibration piece; and calculate an offset of at least one of the plurality of calibration holes according to the first standard pitch and the second standard pitch.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a workpiece processed by a laser drilling calibration system according to an embodiment of the present disclosure.

FIG. 2 is a flow chart showing steps of a laser drilling calibration method according to an embodiment of the present disclosure.

FIG. 3 shows schematic top views of a calibration pattern and a calibration piece according to an embodiment of the present disclosure.

FIG. 4 is a schematic diagram showing parameters of the calibration piece in FIG. 3.

FIG. 5 shows schematic top views of a design pattern and a calibrated design pattern according to an embodiment of the present disclosure.

FIG. 6 is a schematic diagram showing a calibration step according to an embodiment of the present disclosure.

FIG. 7 is a schematic top view of a calibration piece according to another embodiment of the present disclosure.

FIG. 8 is a schematic diagram showing an overlap of a calibration pattern and the calibration piece in FIG. 7 according to another embodiment of the present disclosure.

FIG. 9 shows cross-sectional schematic diagrams of the calibration piece in FIG. 7 taken along line A-A′.

FIG. 10 shows schematic top views of a calibration pattern and a calibration piece according to another embodiment of the present disclosure.

### DETAILED DESCRIPTION

In the following detailed description of the embodiments, reference is made to the accompanying drawings which form a part thereof, and in which is shown by way of illustration specific embodiments in which the disclosure may be practiced. In this regard, directional terminology, such as up, down, left, right, front, back, bottom or top is used with reference to the orientation of the Figure(s) being described. The elements of the present disclosure can be positioned in a number of different orientations. As such, the directional terminology is used for purposes of illustration and is in no way limiting. In addition, identical numeral references or similar numeral references are used for identical elements or similar elements in the following embodiments.

Hereinafter, for the description of “the first feature is formed on or above the second feature”, it may refer that “the first feature is in contact with the second feature directly”, or it may refer that “there is another feature between the first feature and the second feature”, such that the first feature is not in contact with the second feature directly.

It is understood that, although the terms first, second, etc. may be used herein to describe various elements, regions, layers and/or sections, these elements, regions, layers and/or sections should not be limited by these terms. These terms may be only used to distinguish one element, region, layer and/or section from another element, region, layer and/or section. Terms such as “first,” “second,” and other numerical terms when used herein do not imply a sequence or order unless clearly indicated by the context. Thus, a first element, region, layer and/or section discussed below could be termed a second element, region, layer and/or section without departing from the teachings of the embodiments. The terms used in the claims may not be identical with the terms used in the specification, but may be used according to the order of the elements claimed in the claims.

In the present disclosure, a length of an element in a direction may refer a projected length of the element in the direction. A space or a distance between two elements in a direction may refer a projected space or a projected distance between the two elements in the direction.

In the present disclosure, for the convenience of explanation, the following drawings are described in conjunction with the XYZ Cartesian coordinate system. In addition, for the convenience of explanation, when an element has an area on a plane, the position of the element on the plane may be represented by a central point of the element on the plane. For example, a central point of a predetermined position may represent the predetermined position, and a central point of a calibration hole may represent the position of the calibration hole.

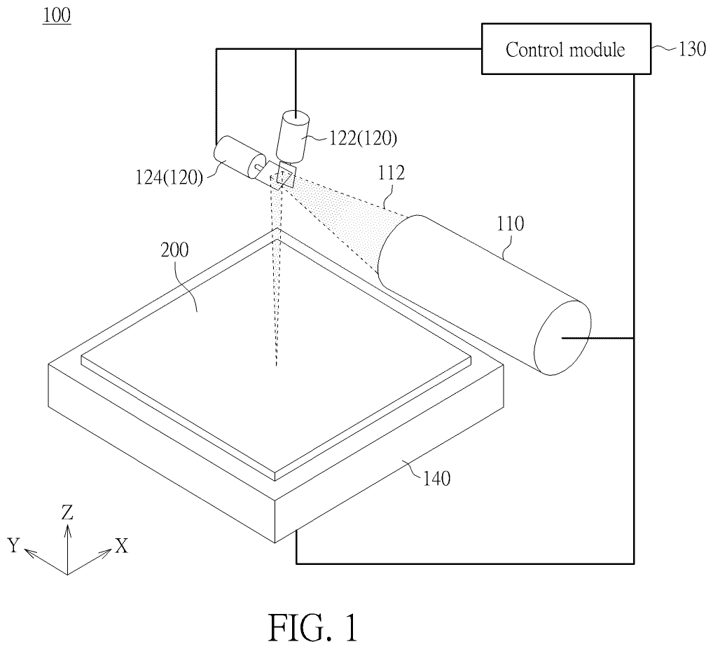

Please refer to FIG. 1, which is a schematic diagram showing a workpiece 200 processed by a laser drilling calibration system 100 according to an embodiment of the present disclosure. The laser drilling calibration system 100 includes a laser source 110, a beam adjustment unit 120, and a control module 130, and may optionally include a carrier 140. The control module 130 is connected to the laser source 110, the beam adjustment unit 120, and the carrier 140.

The laser source 110 is for emitting a laser beam 112. The laser source 110 may be, for example, a fiber laser, an ultraviolet (UV) laser, or a carbon dioxide (CO₂) laser, but not limited thereto. The laser source 110 may further include at least one lens (not shown) disposed on the optical path of the laser beam 112. The control module 130 may control the at least one lens to focus the laser beam 112 and/or control the size and the shape of the spot of the laser beam 112 projected onto the workpiece 200, but not limited thereto.

The beam adjustment unit 120 is for adjusting the direction of the laser beam 112. Herein, the beam adjustment unit 120 is a galvanometer-based laser scanner as an example, which includes a first axial galvanometer 122 and a second axial galvanometer 124. The first axial galvanometer 122 is driven by a corresponding galvanometer motor to control a scanning of the laser beam 112 in a first direction (e.g., direction X), and the second axial galvanometer 124 is driven by a corresponding galvanometer motor to control a scanning of the laser beam 112 in a second direction (e.g., direction Y). With the beam adjustment unit 120, the movement of the laser beam 112 and the position where the laser beam 112 is projected onto the workpiece 200 can be controlled.

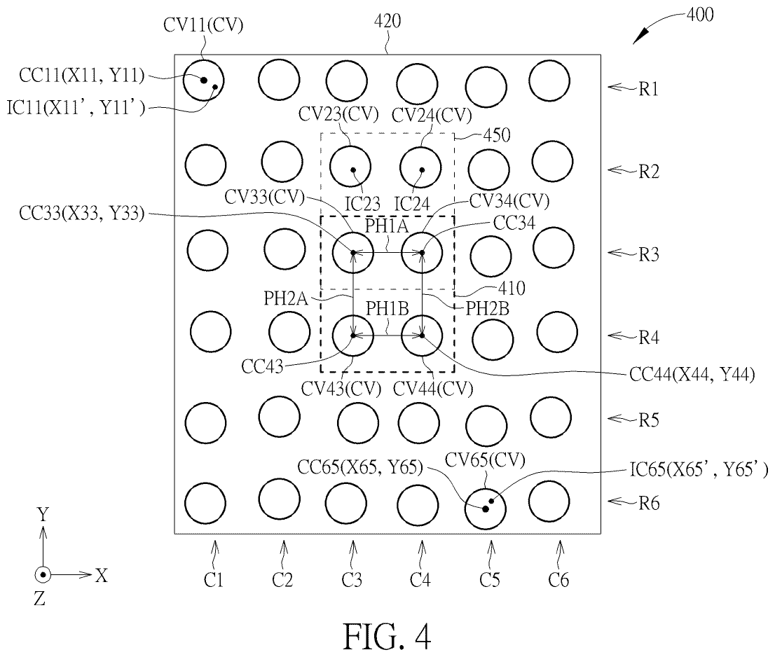

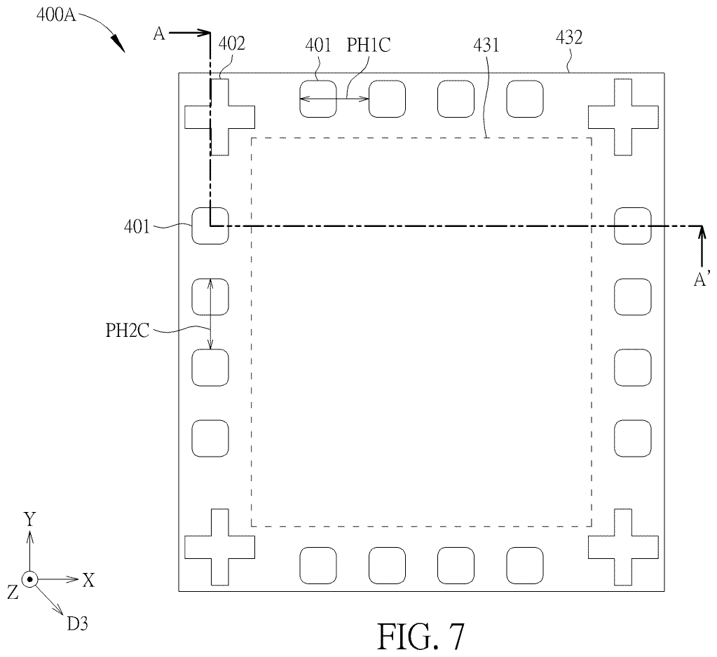

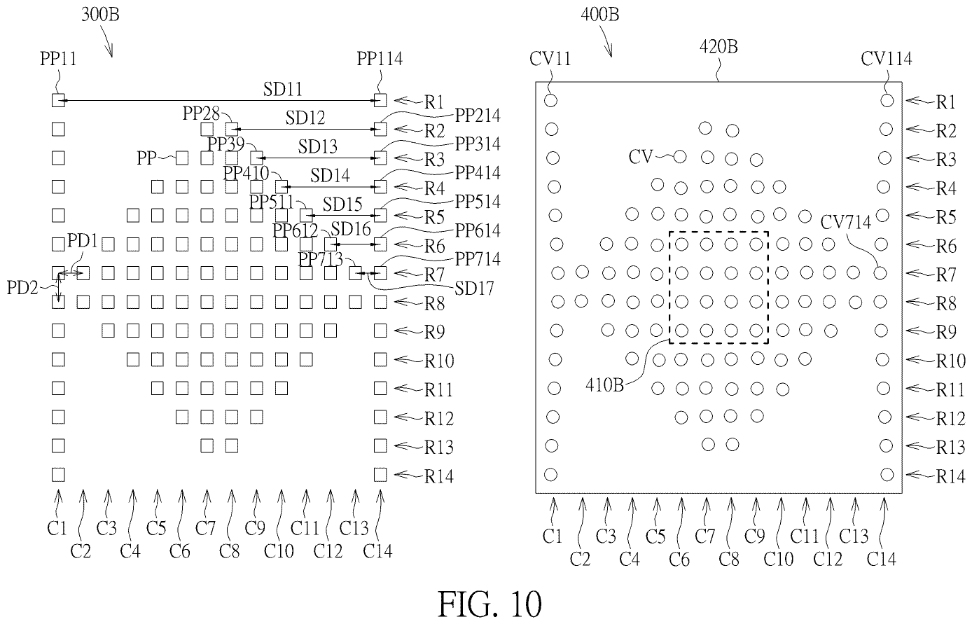

The carrier 140 is for carrying the workpiece 200. The workpiece 200 may be, for example, the calibration piece 400 (see FIG. 4), the calibration piece 400A (see FIG. 7), the calibration piece 400B (see FIG. 10) or a final product (not shown, hereinafter, a product piece).

The connection between the control module 130 and the laser source 110, the beam adjustment unit 120 and the carrier 140 may be a wired connection or a wireless connection. Thereby, information can be transmitted between the control module 130 and the laser source 110, the beam adjustment unit 120 and the carrier 140. For example, the control module 130 can control the focus depth, power, pulse width, repetition frequency and other parameters of the laser source 110. The control module 130 can control the rotation angle of the beam adjustment unit 120 to control the scanning trajectory of the laser beam 112. The control module 130 can control the movement and rotation of the carrier 140 in different axes. The aforementioned axes may be, for example, a first axis parallel to the first direction, a second axis parallel to the second direction, or a third axis perpendicular to the first direction and the second direction (e.g., direction Z), but not limited thereto. In some embodiments, the control module 130 can control the movement and rotation of the carrier 140 through a servo motor driver (not shown) or a stepper motor driver (not shown), but not limited thereto.

The control module 130 has capabilities of analysis and calculation. The control module 130 may be, but not limited to, a central processing unit (CPU). In this embodiment, the control module 130 is a single control unit, which is capable of controlling the laser source 110, the beam adjustment unit 120, and the carrier 140 at the same time, but not limited thereto. In other embodiments, the control module 130 may include a plurality of control units respectively controlling the laser source 110, the beam adjustment unit 120, and the carrier 140. The plurality of control units may be connected in a wired manner or a wireless manner to transmit information to each other.

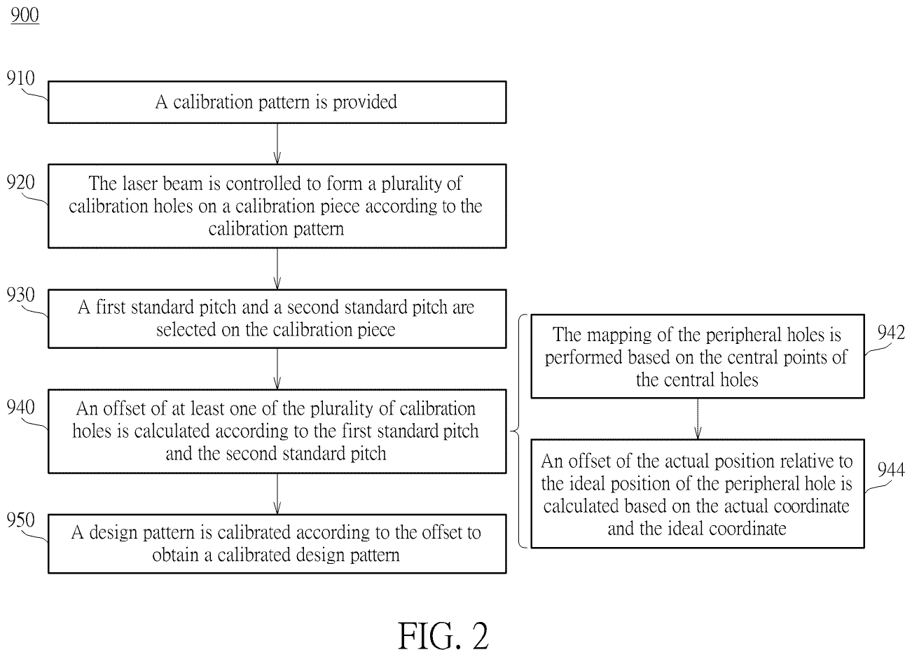

Please refer to FIG. 2, which is a flow chart showing steps of a laser drilling calibration method 900 according to an embodiment of the present disclosure. The laser drilling calibration method 900 may include Step 910 to Step 940, and may optionally include Step 942, Step 944 and Step 950. The laser drilling calibration system 100 in FIG. 1 may be configured to perform the laser drilling calibration method 900. In the following description, how to use the laser drilling calibration system 100 to perform the laser drilling calibration method 900 is illustrated with specific embodiments.

In Step 910, a calibration pattern is provided, wherein the calibration pattern includes predetermined positions of a plurality of calibration holes, the predetermined positions of the plurality of calibration holes are disposed along a first direction and are spaced apart by a multiple of a first predetermined pitch, and are disposed along a second direction and are spaced apart by a multiple of a second predetermined pitch.

The calibration pattern may be produced by electronic design automation (EDA) software (such as AutoCAD, Altium Designer, Cadence, etc.) and stored in an electronic storage device. In Step 910, the calibration pattern may be provided to the control module 130.

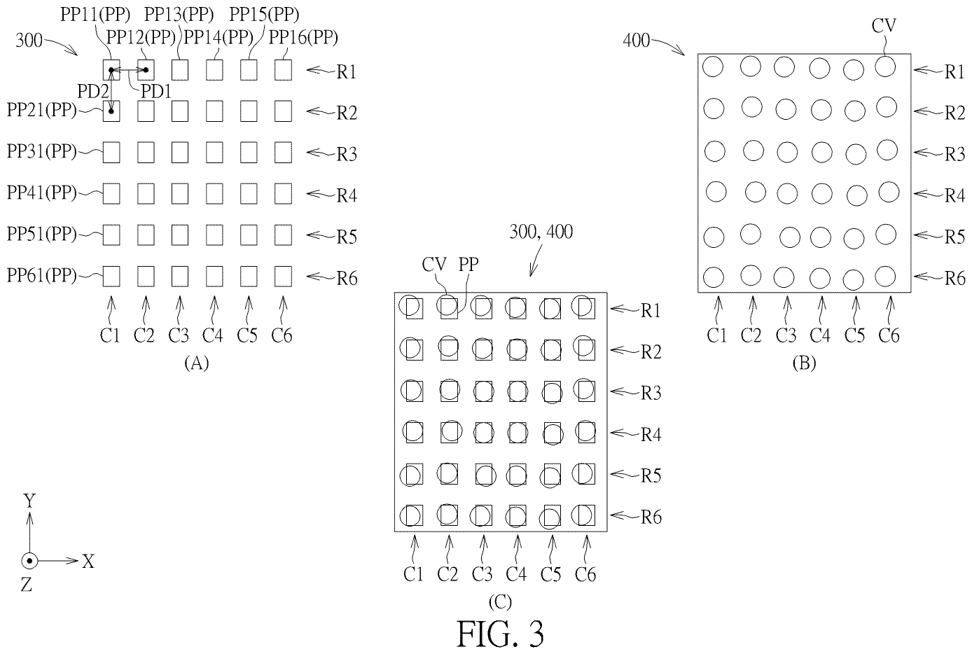

Please refer to FIG. 3, which shows schematic top views of a calibration pattern 300 and a calibration piece 400 according to an embodiment of the present disclosure, in which Part (A) is a schematic top view of the calibration pattern 300, Part (B) is a schematic top view of the calibration piece 400, and Part (C) is a schematic diagram showing the overlap of the calibration pattern 300 and the calibration piece 400. The calibration pattern 300 includes predetermined positions PP of a plurality of calibration holes CV, and the predetermined positions PP of the plurality of calibration holes CV are disposed along a first direction (e.g., direction X) and are spaced apart by a multiple of a first predetermined pitch PD1, and are disposed along a second direction (e.g., direction Y) and are spaced apart by a multiple of a second predetermined pitch PD2. As an example, the first direction is perpendicular to the second direction, but not limited thereto. As long as the first direction and the second direction are not parallel to each other, the plurality of predetermined positions PP can form a two-dimensional pattern.

In detail, in the calibration pattern 300, the plurality of predetermined positions PP are arranged in n rows and m columns to form an n*m array, wherein n and m are positive integers, and n and m may be the same or different. The name of each row of the array may be Ri, the name of each column of the array may be Cj, and each predetermined position PP may be further named as a predetermined position PPij, wherein i represents the i-th row, j represents the j-th column, i and j may be positive integers, and i and j may satisfy the following relationships: 1≤i≤n; and 1≤j≤m.

In FIG. 3, as an example, n is equal to 6, m is equal to 6, and the plurality of predetermined positions PP form an array of 6*6. According to the aforementioned naming rule, the array includes rows R1, R2, R3, R4, R5, and R6 from top to bottom, and the array includes columns C1, C2, C3, C4, C5, and C6 from left to right. In the row R1, the predetermined positions PP are predetermined positions PP11, PP12, PP13, PP14, PP15 and PP16 from left to right. In column C1, the predetermined positions PP are predetermined positions PP11, PP21, PP31, PP41, PP51 and PP61 from top to bottom. The names of the predetermined positions PPij of the remaining rows and columns may follow the same naming rule and are not labeled in the drawing for the sake of simplicity. In FIG. 3, the number of the columns and the number of the rows of the array are for illustrative purposes, and the present disclosure is not limited thereto. The naming rule of the predetermined positions PP of the calibration pattern 300 may be applied to other embodiments below, and will not be repeated.

The aforementioned “first predetermined pitch PD1” may refer to the distance between the central points of two adjacent predetermined positions PP in the first direction, or the distance between the same edges (left edge or right edge) of two adjacent predetermined positions PP in the first direction. Similarly, the aforementioned “second predetermined pitch PD2” may refer to the distance between the central points of two adjacent predetermined positions PP in the second direction, or the distance between the same edges (upper edge or lower edge) of two adjacent predetermined positions PP in the second direction. In FIG. 3, as an example, the first predetermined pitch PD1 is the distance between the central points of two adjacent predetermined positions PP in the first direction, and the second predetermined pitch PD2 is the distance between the central points of two adjacent predetermined positions PP in the second direction.

In the calibration pattern 300, any two adjacent predetermined positions PP are spaced apart by the first predetermined pitch PD1 (i.e., 1 time the first predetermined pitch PD1) along the first direction, and any two adjacent predetermined positions PP are spaced apart by the second predetermined pitch PD2 (i.e., 1 time the second predetermined pitch PD2) along the second direction. In other words, in the calibration pattern 300, the predetermined positions PP are arranged at equal intervals in the first direction, and are arranged at equal intervals in the second direction, but not limited thereto. In some embodiments, two adjacent predetermined positions PP along the first direction may be spaced apart by other integer multiples of the first predetermined pitch PD1 (such as 3 times (in this case, the difference of the column numbers of the two adjacent predetermined positions PP may be 3), but not limited thereto) or by other multiples of the first predetermined pitch PD1 (such as 0.5 times (in this case, the difference of the column numbers of the two adjacent predetermined positions PP may be 0.5), but not limited thereto), and two adjacent predetermined positions PP along the second direction may be spaced apart by other integer multiples of the second predetermined pitch PD2 (such as 2 times (in this case, the difference of the row numbers of the two adjacent predetermined positions PP may be 2), but not limited thereto) or by other multiples of the second predetermined pitch PD2 (such as 1.5 times (in this case, the difference of the row numbers of the two adjacent predetermined positions PP may be 1.5), but not limited thereto), which may be flexibly adjusted according to actual needs. In some embodiments, the calibration pattern 300 may be defined with a central region and a peripheral region corresponding to a central region 410 (see FIG. 4) and a peripheral region 420 (see FIG. 4) of the calibration piece 400, respectively. Two adjacent predetermined positions PP located in the central region may be disposed along the first direction and spaced apart by 1 time the first predetermined pitch PD1, and may be disposed along the second direction and spaced apart by 1 time the second predetermined pitch PD2, while two adjacent predetermined positions PP located in the peripheral region may be disposed along the first direction and spaced apart by any multiple of the first predetermined pitch PD1, and may be disposed along the second direction and spaced apart by any multiple of the second predetermined pitch PD2. Thereby, it is favorable for defining the first standard pitch and the second standard pitch with the central holes in the central region 410, and details thereof may refer to the following description.

Please refer to FIG. 2. In Step 920, the laser beam is controlled to form a plurality of calibration holes on a calibration piece according to the calibration pattern.

Please refer to FIG. 1, FIG. 3 and FIG. 4 at the same time. FIG. 4 is a schematic diagram showing parameters of the calibration piece 400 in FIG. 3. For example, the workpiece 200 in FIG. 1 may be the calibration piece 400. The control module 130 may control the laser source 110 and the beam adjustment unit 120 according to the calibration pattern 300, and further control the laser beam 112 to form the plurality of calibration holes CV on the calibration piece 400. In the calibration piece 400, the plurality of calibration holes CV are arranged in n rows and m columns corresponding to the plurality of predetermined positions PP to form an n*m array. Each calibration hole CV may be further named as a calibration hole CVij. The calibration hole CVij has a central point CCij. Each central point CCij has an actual coordinate (Xij, Yij). For the definition of the parameters n, m, i, and j, references may be made to the above description.

In an ideal state, the calibration holes CV on the calibration piece 400 should completely correspond to the predetermined positions PP of the calibration pattern 300. For example, the central point of the calibration hole CV should coincide with the central point of the corresponding predetermined position PP, or the calibration holes CV on the calibration piece 400 should completely coincide with the predetermined positions PP of the calibration pattern 300 after proportionally scaling. However, in practice, as shown in Part (C) of FIG. 3, there are deviations between the calibration holes CV of the calibration piece 400 and the predetermined positions PP of the calibration pattern 300. The aforementioned deviations may be caused by the stability or accuracy limitation of each component of the laser drilling calibration system 100, or by mechanical deviation, vibration, or heat accumulated by continuously applying the laser beam 112 on the calibration piece 400. Therefore, it is necessary to improve the accuracy of the holes formed by the laser drilling calibration system 100 through calibration. More particularly, to improve the accuracy of the holes located in the peripheral region 420 through calibration. The reason is that when forming the holes in the peripheral region 420, the deflection angles of the first axial galvanometer 122 and the second axial galvanometer 124 of the laser drilling calibration system 100 are relatively large, so that the position deviations of the holes in the peripheral region 420 are more significant.

Please refer to FIG. 2. In Step 930, a first standard pitch and a second standard pitch are selected on the calibration piece. In some embodiments, the first standard pitch and the second standard pitch may be defined by the plurality of central holes. Since the rotation or deflection angle of the beam adjustment unit 120 when forming the central holes is smaller than that when forming the peripheral holes, the alignment control is more precise, so the first standard pitch and the second standard pitch may be defined by the plurality of central holes.

In detail, as shown in FIG. 4, the calibration piece 400 is defined with the central region 410 and the peripheral region 420, the peripheral region 420 surrounds the central region 410, and the calibration holes CV located in the central region 410 are central holes. As an example, the number of the central holes is four, namely, calibration holes CV33, CV34, CV43, and CV44. The plurality of central holes are arranged along the first direction and the second direction to form an array. As an example, the array is a 2*2 array, but not limited thereto. The size of the array formed by the central holes may be determined according to actual needs. As long as the number of the rows of the array is greater than or equal to two, and the number of the columns of the array is greater than or equal to two, the first standard pitch and the second standard pitch may be defined by the central holes, and details thereof may refer to the following description.

The region outside the central region 410 is the peripheral region 420, and the calibration holes CV located in the peripheral region 420 are peripheral holes. As an example, the number of the peripheral holes is 32, such as calibration holes CV11, CV65, etc. For the sake of simplicity, the peripheral holes are not labeled one by one in the drawing.

In the central region 410, the two adjacent calibration holes CV33 and CV34 have a first actual pitch PH1A in the first direction, and the first actual pitch PH1A may be the distance between the central points CC33 and CC34 of the two adjacent calibration holes CV33 and CV34 in the first direction. The two adjacent calibration holes CV43 and CV44 have a first actual pitch PH1B in the first direction, and the first actual pitch PH1B may be the distance between the central points CC43 and CC44 of the two adjacent calibration holes CV43 and CV44 in the first direction. The two adjacent calibration holes CV33 and CV43 have a second actual pitch PH2A in the second direction, and the second actual pitch PH2A may be the distance between the central points CC33 and CC43 of the two adjacent calibration holes CV33 and CV43 in the second direction. The two adjacent calibration holes CV34 and CV44 have a second actual pitch PH2B in the second direction, and the second actual pitch PH2B may be the distance between the central points CC34 and CC44 of the two adjacent calibration holes CV34 and CV44 in the second direction. However, the present disclosure is not limited thereto. The aforementioned first actual pitch may also be the distance between the same edges (left edge or right edge) of two adjacent calibration holes CV in the first direction, and the aforementioned second actual pitch may also be the distance between the same edges (upper edge or lower edge) of two adjacent calibration holes CV in the second direction.

Since the rotation or deflection angle of the beam adjustment unit 120 when forming the central holes is smaller, the alignment control is more precise (for example, much more precise than the alignment control when forming the peripheral holes). In some embodiments, the first actual pitches PH1A and PH1B are the same, or the difference thereof is very small and may be ignored. In this case, any one of the first actual pitches PH1A and PH1B may be served as the first standard pitch. Similarly, in some embodiments, the second actual pitches PH2A and PH2B are the same, or the difference thereof is very small and may be ignored. In this case, any one of the second actual pitches PH2A and PH2B may be served as the second standard pitch. In other embodiments, the first standard pitch may be the mean of the first actual pitches PH1A and PH1B, and the second standard pitch may be the mean of the second actual pitches PH2A and PH2B. In other words, when the central holes may define a plurality of first actual pitches and a plurality of second actual pitches, the first standard pitch may be any one of the plurality of first actual pitches or a mean of the plurality of first actual pitches, and the second standard pitch may be any one of the plurality of second actual pitches or a mean of the plurality of second actual pitches. Specifically, when defining the central region 410, calibration holes with the same first actual pitches or small difference in the first actual pitches and with the same second actual pitches or small difference in the second actual pitches may be selected as the central holes. The aforementioned “small difference”, for example, may refer that the difference is less than 5% of the first predetermined pitch PD1 or is less than 5% of the second predetermined pitch PD2, but not limited thereto. The definition of “small difference” may be flexibly adjusted according to the required accuracy.

Please refer to FIG. 2. In Step 940, an offset of at least one of the plurality of calibration holes is calculated according to the first standard pitch and the second standard pitch. In the embodiment of FIG. 4, the offsets of the peripheral holes are calculated based on the central holes.

In some embodiments, Step 940 may include Step 942 and

Step 944. In Step 942, the mapping of the peripheral holes is performed based on the central points of the central holes, so as to obtain the position of the ideal central point ICij of each peripheral hole and the ideal coordinate (Xij′, Yij′) of the ideal central point ICij. In Step 944, an offset of the actual position relative to the ideal position of the peripheral hole is calculated based on the actual coordinate (Xij, Yij) and the ideal coordinate (Xij′, Yij′). It should be noted that, since the calibration is based on the central holes in this embodiment, the speed for forming the central holes (i.e., the number of holes formed per unit time) by the laser beam 112 is slower than that for forming the peripheral holes. For example, when the laser beam 112 is applied to form a central hole on the calibration piece 400, after the heat generated by the laser beam 112 is dissipated from the calibration piece 400, the laser beam 112 is applied to form another central hole on the calibration piece 400. Therefore, the accuracy of the position of the central hole may be prevented from affecting by the thermal effect. In contrast, the peripheral holes are formed at a normal speed to simulate the actual situation, which is favorable for obtaining the actual offset.

In some embodiments, when the first actual pitches PH1A and PH1B are the same or the difference thereof is very small and may be ignored, and the second actual pitches PH2A and PH2B are the same or the difference thereof is very small and may be ignored, the first standard pitch is any one of the first actual pitches PH1A and PH1B, and the second standard pitch is any one of the second actual pitches PH2A and PH2B. The array formed by the central points of the central holes in the central region 410 can be served as the calibration array. When performing Step 942, the calibration array may be translated outward (including translation upward, downward, leftward, and rightward), and may be gradually translated outward in the radial directions to obtain the positions of the ideal central points ICij of the peripheral holes. For example, in FIG. 4, the central points of the four central holes may be translated upward by a distance of a second standard pitch (herein, the second actual pitch PH2A or PH2B), as shown in the rectangular frame 450, so that the original central point CC43 is translated to coincide with the central point CC33 and the original central point CC44 is translated to coincide with the central point CC34, and the original central point CC33 is translated in the calibration hole CV23 and the original central point CC34 is translated in the calibration hole CV24. The position of the central point CC33 translated in the calibration hole CV23 is the position of the ideal central point IC23 of the calibration hole CV23, and the position of the central point CC34 translated in the calibration hole CV24 is the position of the ideal central point IC24 of the calibration hole CV24. The above steps may be repeated till all the positions of the ideal central points ICij of all the peripheral holes are obtained, and the ideal coordinates (Xij′, Yij′) of all the ideal central points ICij may be calculated accordingly, but not limited thereto.

In some other embodiments, when the mean of the first actual pitches PH1A and PH1B is served as the first standard pitch, and the mean of the second actual pitches PH2A and PH2B is served as the second standard pitch, the positions of the central holes can be calibrated according to the first standard pitch and the second standard pitch to obtain a calibration array. For example, the central point CC33 of the calibration hole CV33 can be served as a reference point, the ideal central point of the calibration hole CV34 may be obtained by translating the reference point rightward by a distance of the first standard pitch, the ideal central point of the calibration hole CV43 may be obtained by translating the reference point downward by a distance of the second standard pitch, and the ideal central point of the calibration hole CV44 may be obtained by translating the reference point rightward by a distance of the first standard pitch and downward by a distance of the second standard pitch. The central point CC33 of the calibration hole CV33 and the ideal central points of the calibration holes CV34, CV43, and CV44 may be served as the calibration array. The remaining steps may refer to the description of Step 942 above, the positions of the ideal central points ICij of all the peripheral holes can be obtained, and the ideal coordinates (Xij′, Yij′) of all the ideal central points ICij can be calculated accordingly, but not limited thereto.

In some other embodiments, when performing Step 942, any one of the central points of the central holes may be selected as the reference point to obtain the positions of the ideal central points ICij of the remaining central holes and the peripheral holes and the ideal coordinates (Xij′, Yij′) thereof. The following explanation uses calibration hole CV11 as an example. First, a central point of a central hole may be selected as the reference point. Herein, the central hole (calibration hole CV33) closest to the calibration hole CV11 is selected as an example, but not limited thereto. Next, the ideal distance difference between the calibration holes CV11 and CV33 in the first direction and the ideal distance difference between the calibration holes CV11 and CV33 in the second direction are calculated. The calculation formulas are as Formulas (I) and (II): S1=D1×PH1 (I); S2=D2×PH2 (II).

In Formula (I), S1 is the ideal distance difference between the selected peripheral hole (herein, the calibration hole CV11) and the selected central hole (herein, the calibration hole CV33) in the first direction, D1 is the column number of the selected peripheral hole minus the column number of the selected central hole (i.e., the difference between the column numbers of the selected peripheral hole and the selected central hole, when the predetermined position of the selected peripheral hole and the predetermined position of the selected central hole are not spaced apart by an integer multiple of the first predetermined pitch PD1, the corresponding difference between the column numbers may be calculated by interpolation or extrapolation, that is, the difference between the column numbers is not necessarily an integer), PH1 is the first standard pitch (as mentioned above, may be the first actual pitch PH1A, PH1B or the mean of the first actual pitches PH1A and PH1B). Herein, D1=1−3=−2. Substituting D1=−2 into Formula (I) gives S1=−2PH1. In Formula (II), S2 is the ideal distance difference between the selected peripheral hole (herein, the calibration hole CV11) and the selected central hole (herein, the calibration hole CV33) in the second direction, D2 is the row number of the selected central hole minus the row number of the selected peripheral hole (i.e., the difference between the row numbers of the selected central hole and the selected peripheral holes, when the predetermined position of the selected peripheral hole and the predetermined position of the selected central hole are not spaced by an integer multiple of the second predetermined pitch PD2, the corresponding difference between the row number may be calculated by interpolation or extrapolation, that is, the difference between the row numbers is not necessarily an integer), PH2 is the second standard pitch (as mentioned above, may be the second actual pitch PH2A, PH2B or the mean of the second actual pitches PH2A and PH2B). Herein, D2=3−1=2. Substituting D2=2 into Formula (II) gives S2=2PH2. S1 may be the translation amount of the central point CC33 in the first direction, and S2 may be the translation amount of the central point CC33 in the second direction. That is, the central point CC33 is translated leftward by two first standard pitches and translated upward by two second standard pitches, so that the ideal position of the ideal central point IC11 of the calibration hole CV11 may be obtained, and its ideal coordinate (X11′, Y11′) being (X33−2PH1, Y33+2PH2) may be obtained.

Take the calibration hole CV44 as the reference point to obtain the ideal central point IC65 of the calibration hole CV65 and its ideal coordinate (X65′, Y65′) as another example. According to the above Formulas (I) and (II), the ideal distance difference between the calibration hole CV65 and the calibration hole CV44 in the first direction and the ideal distance difference between the calibration hole CV65 and the calibration hole CV44 in the second direction are calculated, and S1=PH1, S2=−2PH2 can be obtained. That is, the central point CC44 is translated rightward by one first standard pitch and translated downward by two second standard pitches, so that the ideal position of the ideal central point IC65 of the calibration hole CV65 may be obtained, and its ideal coordinate (X65′, Y65′) being (X44+PH1, Y44−2PH2) may be obtained.

In some embodiments, any point on the calibration piece 400 (e.g., the central point of the entire calibration piece 400, or the central point of the 2*2 array formed by the central holes in the central region 410 (i.e., the central point of the rectangle formed by connecting the central points CC33, CC34, CC43 and CC44 of the calibration holes CV33, CV34, CV43 and CV44)) may be served as a reference point, and the ideal central points ICij and ideal coordinates (Xij′, Yij′) of all calibration holes CV may be calculated in conjunction with the selected first standard pitch and the selected second standard pitch.

It can be seen from the above description that the present disclosure can use the calibration array formed by the central holes in the central region, in conjunction with the selected first standard pitch and the selected second standard pitch, to expand outward to obtain the ideal positions and ideal coordinates of the peripheral holes in the peripheral region. The present disclosure can also directly use any point on the calibration piece (such as the central point of one of the central holes in the central region or the central point of the entire calibration piece or the central point of the array formed by the central holes in the central region) as a reference point, in conjunction with the selected first standard pitch and the selected second standard pitch, to directly calculate the ideal positions and the ideal coordinates of the ideal central points of the remaining calibration holes. However, the above methods are for illustrative purposes, and the present disclosure is not limited thereto.

In Step 944, the offset of the actual position of the peripheral hole may include a first offset ΔX in the first direction and a second offset ΔY in the second direction, which may be calculated by Formula (III) and (IV): ΔX=Xij−Xij′ (III); ΔY=Yij−Yij′(IV). In Formula (III), ΔX is the first offset, and in Formula (IV), ΔY is the second offset.

The following explanation continuously uses the calibration hole CV11 as an example. The ideal coordinate (X11′, Y11′) of the ideal central point IC11 of the calibration hole CV11 and the actual coordinate (X11, Y11) of the central point CC11 of the calibration hole CV11 are substituted into Formulas (III) and (IV), and the following relationships may be obtained: ΔX=X11−X11′=X11−X33+2PH1; and ΔY=Y11−Y11′=Y11−Y33−2PH2. Similarly, the ideal coordinate (X65′, Y65′) of the ideal central point IC65 of the calibration hole CV65 and the actual coordinate (X65, Y65) of the central point CC65 of the calibration hole CV65 are substituted into Formulas (III) and (IV) to obtain the corresponding first offset ΔX and the corresponding second offset ΔY. An offset calibration pattern may be obtained based on the predetermined position PP and the offset of each of the calibration holes CV.

Step 940 can be performed by using a high-resolution camera, a high-resolution microscope (e.g., a scanning electron microscope) or other device to obtain an image of the calibration holes CV of the calibration piece 400 in conjunction with image processing. In some embodiments, the central point CCij and the ideal central point ICij of each of the calibration holes CVij may be directly marked on the image of the calibration holes CVij, and the offset can be obtained by directly measuring the distance between the central point CCij and the ideal central point ICij of each of the calibration holes CVij in the image. In other embodiments, the actual coordinate (Xij, Yij) of each of the calibration holes CVij, the first actual pitches PH1A and PH1B and the second actual pitches PH2A and PH2B can be directly measured in the image of the calibration holes CVij, and then the offset of each of the calibration holes CVij can be calculated accordingly. How to obtain the image of the calibration holes CV of the calibration piece 400 and how to obtain the aforementioned data by the image processing are well known in the art and are omitted herein.

Please refer to FIG. 2. In Step 950, a design pattern is calibrated according to the offset to obtain a calibrated design pattern.

The offset calibration pattern collected by Step 910 to Step 940 may be applied to the product piece.

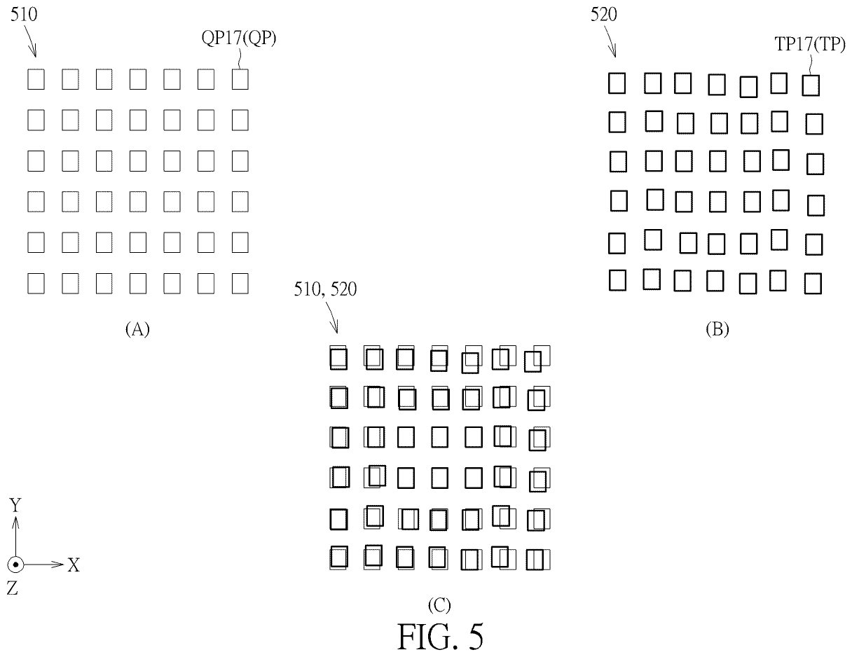

Please refer to FIG. 5 at the same time, FIG. 5 shows schematic top views of a design pattern 510 and a calibrated design pattern 520 according to an embodiment of the present disclosure, wherein Part (A) is a schematic top view of the design pattern 510, Part (B) is a schematic top view of the calibrated design pattern 520, and Part (C) is a schematic diagram showing an overlap of the design pattern 510 and the calibrated design pattern 520. First, the control module 130 is provided with the design pattern 510, and the design pattern 510 includes predetermined positions QP of a plurality of formal holes, and the predetermined positions QP of the plurality of formal holes may be further named as predetermined positions QPij. For the definitions of i and j, references may be made to the above description.

The control module 130 can calculate the offset corresponding to the predetermined position QP of each of the formal holes according to the offset calibration pattern collected by Step 910 to Step 940, and obtain the calibrated position TP of each of the predetermined positions QP, and then obtain the calibrated design pattern 520. The calibrated design pattern 520 includes the calibrated positions TP of the plurality of formal holes. The calibrated positions TP of the plurality of formal holes may be further named as calibrated positions TPij. For the definitions of i and j, references may be made to the above description.

In some embodiments, when the predetermined position QP of a formal hole is the same as the predetermined position PP of one of the calibration holes CV in the offset calibration pattern, the offset of the predetermined position PP may be directly served as the corresponding offset of the formal hole. When the predetermined position QP of a formal hole is different from all the predetermined positions PP in the offset calibration pattern, two or one of the closest predetermined positions PP in the offset calibration pattern may be selected as the reference, and then the corresponding offset of the predetermined position QP of the formal hole can be calculated by using interpolation or extrapolation. However, the aforementioned methods are for illustrative purposes, and the present disclosure is not limited thereto.

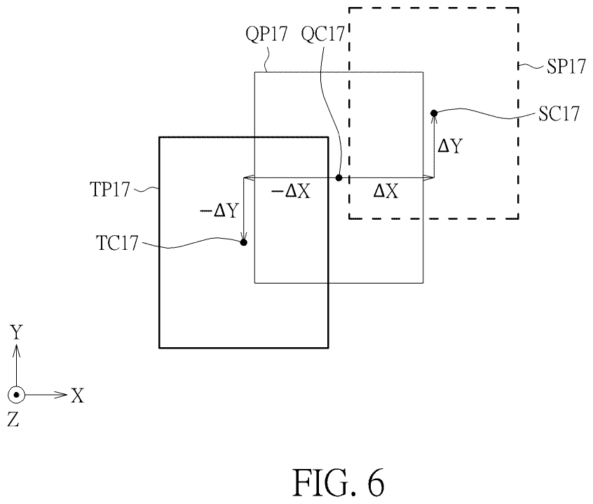

Please refer to FIG. 6, which is a schematic diagram showing a calibration step according to an embodiment of the present disclosure. In FIG. 6, the predetermined position QP17 in FIG. 5 is used as an example to illustrate how to obtain the calibrated position TP17. The predetermined position QP17 has a central point QC17, and the first offset ΔX in the first direction and the second offset ΔY in the second direction can be obtained by calculation. It can be expected that when the laser drilling calibration system 100 forms a hole based on the data of the predetermined position QP17, a hole located at the deviation position SP17 having a central point SC17 will be obtained. In order to avoid this situation, the control module 130 provides a calibration amount to the predetermined position QP17 to obtain the calibrated position TP17 having a central point TC17. The calibration amount may include a first calibration amount in the first direction and a second calibration amount in the second direction. The first calibration amount may be the negative value of the first offset ΔX (i.e. −ΔX), and the second calibration amount may be the negative value of the second offset ≢Y (i.e. −ΔY). When the laser drilling calibration system 100 forms a formal hole based on the data of the calibrated position TP17, the first offset ΔX and the second offset ΔY are generated, the first calibration amount (i.e. −ΔX) neutralizes the first offset ≢X, and the second calibration amount (i.e. −ΔY) neutralizes the second offset ΔY, so that the position of the formal hole can be located at the desired predetermined position QP17.

From the above description, it can be seen that the present disclosure provides a calibration amount opposite to the offset to each predetermined position QP in the design pattern 510 to obtain the calibrated position TP after the offset is calculated, and then obtains the calibrated design pattern 520. When the laser drilling calibration system 100 forms a formal hole according to the calibrated design pattern 520, the calibration amount neutralizes the offset, so that the deviation between the position of the formal hole and the predetermined position QP in the design pattern 510 can be reduced.

Furthermore, the laser drilling calibration method 900 according to the present disclosure calibrates the positions of the holes by calibrating the design pattern, rather than adjusting the machine. The conventional calibration method is to adjust the machine. Since various units of the machine are linked to each other, the adjustment is difficult. The present disclosure can apply the relationship between the predetermined position and the offset of the calibration hole collected by the calibration piece to different design patterns, so as can obtain the offset of each predetermined position in the design pattern and then can calibrate the design pattern without adjusting the machine according to different design patterns and/or different predetermined positions of the holes. Therefore, the laser drilling calibration method 900 according to the present disclosure has the advantages of high versatility and improved calibration efficiency. In addition, when mass production is carried out, multiple laser drilling calibration systems 100 are required at the same time. Even if the models and specifications of the components in the multiple laser drilling calibration systems 100 are the same, due to the problem of assembly accuracy, different offsets may be generated in different laser drilling calibration systems 100 when forming holes at the same position. That is, different laser drilling calibration systems 100 have different system errors. In the laser drilling calibration method 900 according to the present disclosure, calibration pieces can be used in multiple laser drilling calibration systems 100 to obtain the relationship between the predetermined position and the offset of the calibration hole for each of the laser drilling calibration systems 100. Therefore, customized calibration results can be provided for each of the laser drilling calibration systems 100, which is beneficial to reduce the influence caused by system errors.

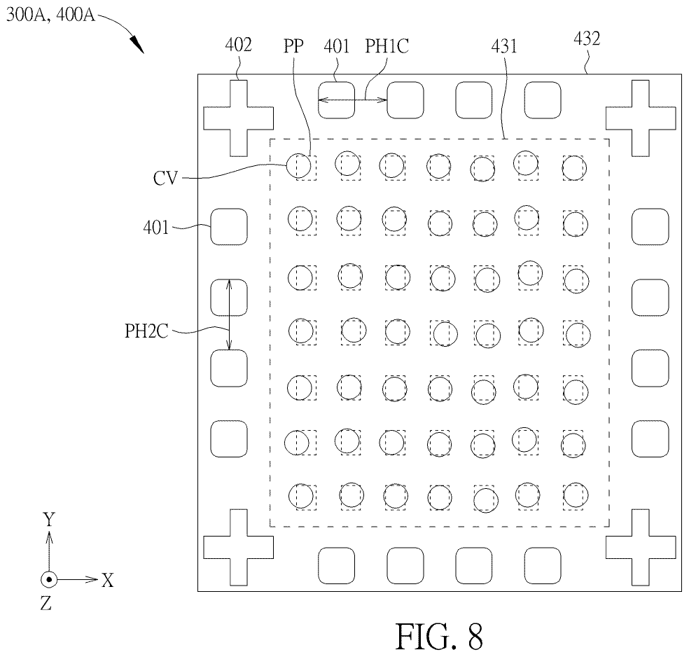

Please refer to FIG. 7 and FIG. 8. FIG. 7 is a schematic top view of a calibration piece 400A according to another embodiment of the present disclosure. In FIG. 7, the calibration piece 400A has not yet been formed with calibration holes CV. FIG. 8 is a schematic diagram showing an overlap of a calibration pattern 300A and the calibration piece 400A in FIG. 7 according to another embodiment of the present disclosure. In FIG. 8, the calibration piece 400A has been formed with the calibration holes CV.

In the top view of the calibration piece 400A, the calibration piece 400A is defined with a device region 431 and a non-device region 432 disposed adjacent to each other. The device region 431 is a region predetermined to form the plurality of calibration holes CV. Herein, the non-device region 432 surrounds the device region 431, but not limited thereto. In some embodiments, the device region 431 and the non-device region 432 may be disposed alternatively. The calibration piece 400A includes a plurality of standard patterns 401 disposed in the non-device region 432, wherein at least two standard patterns 401 are arranged along a first direction (e.g., direction X), and at least two standard patterns 401 are arranged along a second direction (e.g., direction Y). The first standard pitch may be defined by the standard patterns 401 arranged along the first direction, and the second standard pitch may be defined by the standard patterns 401 arranged along the second direction. The standard patterns 401 can be formed on the calibration piece 400A in advance by a patterning process, and the patterning process may be the same or different patterning processes. The patterning process may include an optical lithography process, an electron beam lithography process or a laser lithography process, but not limited thereto. The laser lithography process may be, for example, a laser direct writing (LDW) process, but not limited thereto. The optical lithography process may include a stepper exposure process, a scanner exposure process, or a step-and-scan exposure process, but not limited thereto. Thereby, the standard pattern 401 can have higher position accuracy and can be used as a reference for calculating the offset.

For example, two adjacent standard patterns 401 arranged along the first direction have a first actual pitch PH1C in the first direction, and two adjacent standard patterns 401 arranged along the second direction have a second actual pitch PH2C in the second direction. When there are multiple standard patterns 401 in the first direction defining multiple first actual pitches PH1C, and the difference between the multiple first actual pitches PH1C is very small and may be ignored, any one of the multiple first actual pitches PH1C may be served as the first standard pitch, but not limited thereto. The mean of the multiple first actual pitches PH1C may also be served as the first standard pitch. Similarly, when there are multiple standard patterns 401 in the second direction defining multiple second actual pitches PH2C, and the difference between the multiple second actual pitches PH2C is very small and may be ignored, any one of the multiple second actual pitches PH2C may be served as the second standard pitch, but not limited thereto. The mean of the multiple second actual pitches PH2C may also be served as the second standard pitch. After the first standard pitch and the second standard pitch are selected, Steps 940 and 950 may be performed, and details may refer to the above description and are not repeated herein.

The calibration piece 400A may further include at least two marking elements 402 disposed in the non-device region 432, and the at least two marking elements 402 are spaced apart along a third direction D3 not parallel to the first direction (e.g., direction X) and the second direction (e.g., direction Y). The marking element 402 may be, for example, an alignment mark, which can be served as a reference for the laser drilling calibration system 100 to calculate the position of each calibration hole CV on the calibration piece 400A. By arranging at least two marking elements 402 along the third direction D3 that is different from the first direction and the second direction, the at least two marking elements 402 have a distance difference in the first direction and a distance difference in the second direction, respectively. Therefore, the at least two marking elements 402 may be served as the positioning reference in the first direction and the second direction. With the at least two marking elements 402, the accuracy of the hole positions of the calibration holes CV can be improved.

In the calibration piece 400A, the numbers of standard patterns 401 and marking elements 402 are only for illustrative purposes. In the first direction, as long as there are two standard patterns 401, the first standard pitch may be defined. In the second direction, as long as there are two standard patterns 401, the second standard pitch may be defined. Moreover, as long as there are two marking elements 402 spaced apart along the third direction D3 that is not parallel to the first direction and the second direction, the distance difference in the first direction and the distance difference in the second direction may be provided as the positioning references. In other words, the number of the standard patterns 401 disposed along the first direction is greater than or equal to two, the number of the standard patterns 401 disposed along the second direction is greater than or equal to two, and the number of the marking elements 402 disposed along the third direction D3 is greater than or equal to two, all of which fall within the scope of the present disclosure. In addition, in the present embodiment, the shapes of the standard patterns 401 and the marking elements 402 are only for illustrative purposes and may be flexibly adjusted according to actual needs, and the shapes of the standard patterns 401 arranged along the first direction and the standard patterns 401 arranged along the second direction may be different.

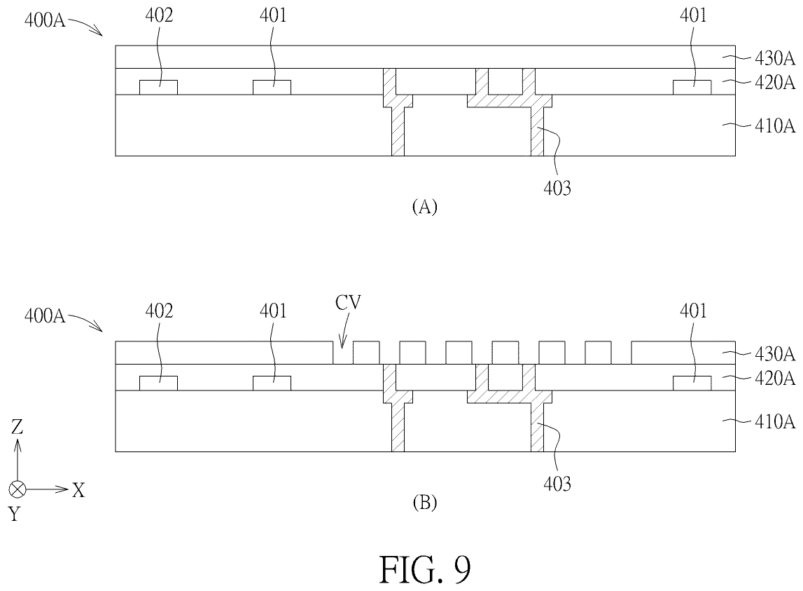

Please refer to FIG. 9, which shows cross-sectional schematic diagrams of the calibration piece 400A in FIG. 7 taken along line A-A′. In Part (A) of FIG. 9, the calibration holes CV have not yet been formed on the calibration piece 400A. In Part (B), the calibration holes CV have been formed on the calibration piece 400A. In some embodiments, the calibration piece 400A may include a plurality of sublayers. Herein, the number of sublayers is three as an example, which are sublayers 410A, 420A and 430A from bottom to top, but not limited thereto. The number of the sublayers may be adjusted according to actual needs. The sublayer 420A is disposed on the sublayer 410A, the sublayer 430A is disposed on the sublayer 420A, the standard patterns 401 and the marking elements 402 are disposed in the sublayer 420A, and the calibration holes CV are disposed in the sublayer 430A. The sublayer 420A and the sublayer 430A are disposed with conductive wires 403, and may optionally include active elements (not shown) and/or passive elements (not shown). The active elements, for example, may be transistors. The passive elements, for example, may be capacitors, inductors, etc., but limited thereto. The calibration holes CV expose at least one conductive wire 403. In some embodiments, the conductive wires 403 may be formed by an optical lithography process, and standard patterns 401 and the marking elements 402 may be formed together in the process of forming the conductive wires 403, but not limited thereto. The conductive wires 403, the standard patterns 401 and the marking elements 402 may also be separately formed by different processes. In FIG. 9, the standard patterns 401 and the marking elements 402 are disposed in the sublayer 420A as an example, but not limited thereto. The standard patterns 401 and the marking elements 402 may also be disposed in the sublayer 410A or the sublayer 430A independently.

For example, in some embodiments, the product piece (not shown) may include a device substrate (corresponding to the sublayers 410A and 420A of the calibration piece 400A) and a hole substrate (corresponding to the sublayer 430A of the calibration piece 400A) for forming the formal holes. The material of the hole substrate may include silicon or dielectric materials, but not limited thereto. When manufacturing the product piece, the hole substrate is first bonded to the device substrate, and the hole substrate may be thinned according to actual needs. Next, formal holes are formed on the hole substrate by the laser drilling calibration system 100. Next, a conductor layer may be formed in the formal holes to electrically connect with the conductive wires and/or the active elements and/or the passive elements in the device substrate. When the hole substrate is bonded to the device substrate, the coefficient of thermal expansion, warpage degree, etc. of the device substrate may also affect the offset of the formal holes. Therefore, the calibration piece 400A may include a plurality of sublayers the same as the structure of the product piece, wherein the sublayers 410A and 420A may be the layers of the device substrate, and the sublayer 430A can be the layer of the hole substrate. With the calibration piece 400A and the product piece having the same structure, the influence of the device substrate on the offset of the formal holes can be corrected at the same time. Moreover, when the standard patterns 401 and the marking elements 402 are disposed in the sublayer 410A or the sublayer 420A, the existing elements of the device substrate are used as the basis for calculating the offset. Therefore, no additional steps are required to form the standard patterns 401 and the marking elements 402, which is beneficial to simplify the process of the laser drilling calibration method 900 and improve the calibration efficiency.

Please refer to FIG. 10, which shows schematic top views of a calibration pattern 300B and a calibration piece 400B according to another embodiment of the present disclosure, wherein Part (A) is a schematic top view of the calibration pattern 300B, and Part (B) is a schematic top view of the calibration piece 400B.

The calibration pattern 300B includes predetermined positions PP of a plurality of calibration holes CV. The predetermined positions PP of the plurality of calibration holes CV are disposed along a first direction (e.g., direction X) and are spaced apart by an integer multiple of a first predetermined pitch PD1, and are disposed along a second direction (e.g., direction Y) and are spaced apart by an integer multiple of a second predetermined pitch PD2. Herein, in the calibration pattern 300B, the number of the rows of the predetermined positions PP is 14, which are rows R1, R2, R3, R4, R5, R6, R7, R8, R9, R10, R11, R12, R13 and R14 from top to bottom, and the number of the columns of the predetermined positions PP is 14, which are columns C1, C2, C3, C4, C5, C6, C7, C8, C9, C10, C11, C12, C13 and C14 from left to right. For example, in the row R1, the predetermined position PP11 and the predetermined position PP114 are spaced apart by a distance SD11 along the first direction, which satisfies the following condition: SD11=13PD1. In the row R2, the predetermined position PP28 and the predetermined position PP214 are spaced apart by a distance SD12 along the first direction, which satisfies the following condition: SD12=6PD1. In the row R3, the predetermined position PP39 and the predetermined position PP314 are spaced apart by a distance SD13 along the first direction, which satisfies the following condition: SD13=5PD1. In the row R4, the predetermined position PP410 and the predetermined position PP414 are spaced apart by a distance SD14 along the first direction, which satisfies the following condition: SD14=4PD1. In the row R5, the predetermined position PP511 and the predetermined position PP514 are spaced apart by a distance SD15 along the first direction, which satisfies the following condition: SD15=3PD1. In the row R6, the predetermined position PP612 and the predetermined position PP614 are spaced apart by a distance SD15 along the first direction, which satisfies the following condition: SD15=2PD1. In the row R7, the predetermined position PP713 and the predetermined position PP714 are spaced apart by a distance SD17 along the first direction, which satisfies the following condition: SD17=PD1. As can be seen from the above description, in the plurality of calibration holes CV of the calibration pattern 300B, the distance between two adjacent predetermined positions PP along the first direction may be different from the distance between another two adjacent predetermined positions PP along the first direction.

When the laser beam 112 is controlled to form the calibration holes CV on the calibration piece 400B according to the calibration pattern 300B, and when the distances between two adjacent predetermined positions PP are different, the offset of the calibration hole CV may be different. Taking the calibration holes CV of the column 14 as an example, when the control module 130 controls the laser beam 112 to scan continuously from left to right along the first direction to form the calibration holes CV of each row on the calibration piece 400B, the calibration holes CV of the column C14 are the holes formed last in each row. When the calibration hole CV114 of the row R1 is formed, only the calibration hole CV11 is formed before forming the calibration hole CV114. Therefore, the heat generated by the laser beam 112 accumulated in the calibration piece 400B is lower, and the degree of thermal expansion of the calibration piece 400B is also lower. When the calibration hole CV714 of the row R7 is formed, the other thirteen calibration holes CV of the row R7 are formed before forming the calibration hole CV714. Therefore, the calibration piece 400B absorbs more heat generated by the continuous application of the laser beam 112, and the degree of thermal expansion of the calibration piece 400B is more serious. Accordingly, when the calibration piece 400B is cooled and contracted, the degree of the position of the calibration hole CV714 moving toward left is larger due to the contraction of the calibration piece 400B. Therefore, based on the influence of the thermal effect, the degree of positions of the calibration holes of the column 14 moving inwardly is increased gradually form the row R1 to the row R7, and the degree of positions of the calibration holes of the column 14 moving inwardly is decreased gradually form the row R8 to the row R14. The relationship between the distance between two adjacent predetermined positions PP and the offset can be obtained through the calibration piece 400B. The method for calculating the offset of each calibration hole CV in the calibration piece 400B may be similar to the method of the embodiments in FIG. 3 and FIG. 4. That is, the calibration piece 400B may be defined with a central region 410B and a peripheral region 420B, a first standard pitch and a second standard pitch may be defined by a plurality of central holes, and details may refer to the relevant description of Step 940 above. As for how to calibrate the design pattern according to the offset to obtain a calibrated design pattern, reference may be made to the relevant description of Step 950 above.

In addition to the distance between two adjacent predetermined positions PP affecting the offset, the application conditions of the laser beam 112, such as the laser power, the scanning speed, etc., also affect the offset. In the present disclosure, the calibration piece may be manufactured under different conditions, so as to obtain different relationships of different conditions and the offset.

In some embodiments, the relationship between the predetermined position PP and the offset and the relationship between the distances between two adjacent predetermined positions PP and the offset may be obtained by the calibration pattern 300 in FIG. 3 and the calibration pattern 300B in FIG. 9 in the same laser drilling calibration system 100. Different calibration pieces may be manufactured under different conditions in the same laser drilling calibration system 100, so that the offsets under different conditions may be obtained. When the control module 130 receives the design pattern, the control module 130 can analyze the predetermined position of each of the formal holes, the distances between the predetermined positions of the formal holes in the design pattern, as well as the required conditions, and then the design pattern may be calibrated based on the aforementioned collected data to obtain a calibrated design pattern.

Compared with the prior art, the laser drilling calibration method according to the present disclosure forms calibration holes on a calibration piece first, calculates an offset based on a first standard pitch and a second standard pitch selected on the calibration piece, and then calibrates the design pattern of the product piece based on the offset. The first standard pitch and the second standard pitch may be defined by the central holes of the calibration piece or by the existing standard pattern of the calibration piece. In this way, the present disclosure can apply the relationship between the predetermined position and the offset collected by the calibration piece to different design patterns, and can obtain the offset of each predetermined position of the design pattern, and then can calibrate the design pattern. There is no need to adjust the machine for different design patterns and/or different predetermined hole positions or relative coordinate of the substrate. In addition, the laser drilling calibration method according to the present disclosure can provide customized calibration results for each laser drilling calibration system, and can reduce the influence caused by the system error of the laser drilling calibration system.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A laser drilling calibration method, comprising:
providing a calibration pattern, wherein the calibration pattern comprises predetermined positions of a plurality of calibration holes, the predetermined positions of the plurality of calibration holes are disposed along a first direction and are spaced apart by a multiple of a first predetermined pitch, and are disposed along a second direction and are spaced apart by a multiple of a second predetermined pitch;
controlling a laser beam to form the plurality of calibration holes on a calibration piece according to the calibration pattern;
selecting a first standard pitch and a second standard pitch on the calibration piece; and
calculating an offset of at least one of the plurality of calibration holes according to the first standard pitch and the second standard pitch.

2. The laser drilling calibration method of claim 1, further comprising:
calibrating a design pattern according to the offset to obtain a calibrated design pattern.

3. The laser drilling calibration method of claim 1, wherein the offset comprises a first offset in the first direction and a second offset in the second direction.

4. The laser drilling calibration method of claim 1, wherein the calibration piece is defined with a central region and a peripheral region surrounding the central region, the plurality of calibration holes comprise a plurality of central holes located in the central region and a plurality of peripheral holes located in the peripheral region, and the first standard pitch and the second standard pitch are defined by the plurality of central holes.

5. The laser drilling calibration method of claim 4, wherein the plurality of central holes are arranged along the first direction and the second direction to form an array, a number of rows of the array is greater than or equal to two, and a number of columns of the array is greater than or equal to two.

6. The laser drilling calibration method of claim 1, wherein the calibration piece is defined with a device region and a non-device region disposed adjacent to each other, the plurality of calibration holes are formed in the device region, the calibration piece comprises two first standard patterns and two second standard patterns disposed in the non-device region, the two first standard patterns are arranged along the first direction, the two second standard patterns are arranged along the second direction, the first standard pitch is defined by the two first standard patterns, and the second standard pitch is defined by the two second standard patterns.

7. The laser drilling calibration method of claim 6, wherein the two first standard patterns and the two second standard patterns are formed on the calibration piece in advance by a patterning process.

8. The laser drilling calibration method of claim 6, wherein the calibration piece further comprises a first sublayer and a second sublayer, the second sublayer is disposed on the first sublayer, the two first standard patterns and the two second standard patterns are disposed in the first sublayer, and the plurality of calibration holes are disposed in the second sublayer.

9. The laser drilling calibration method of claim 6, wherein the calibration piece further comprises two marking elements disposed in the non-device region, the two marking elements are spaced apart along a third direction, and the third direction is not parallel to the first direction and the second direction.

10. The laser drilling calibration method of claim 9, wherein the calibration piece further comprises a first sublayer and a second sublayer, the second sublayer is disposed on the first sublayer, the two marking elements are disposed in the first sublayer, and the plurality of calibration holes are disposed in the second sublayer.

11. The laser drilling calibration method of claim 1, wherein the predetermined positions of the plurality of calibration holes comprise a first predetermined position and a second predetermined position disposed adjacently along the first direction, and a third predetermined position and a fourth predetermined position disposed adjacently along the first direction, and a distance between the first predetermined position and the second predetermined position is different from a distance between the third predetermined position and the fourth predetermined position.

12. A calibration piece for laser drilling, being defined with a device region and a non-device region disposed adjacently and comprising:
two first standard patterns disposed in the non-device region, wherein the two first standard patterns are arranged along a first direction and define a first standard pitch; and
two second standard patterns disposed in the non-device region, wherein the two second standard patterns are arranged along a second direction and define a second standard pitch.

13. The calibration piece of claim 12, wherein the two first standard patterns and the two second standard patterns are formed on the calibration piece in advance by a patterning process.

14. The calibration piece of claim 13, wherein the patterning process comprises an optical lithography process, an electron beam lithography process or a laser lithography process.

15. The calibration piece of claim 12, further comprising:
a first sublayer; and
a second sublayer disposed on the first sublayer, wherein the two first standard patterns and the two second standard patterns are disposed in the first sublayer, and the second sublayer is configured to dispose a plurality of calibration holes.

16. The calibration piece of claim 12, further comprising:
two marking elements disposed in the non-device region, wherein the two marking elements are spaced apart along a third direction, and the third direction is not parallel to the first direction and the second direction.

17. The calibration piece of claim 16, further comprising:
a first sublayer; and
a second sublayer disposed on the first sublayer, wherein the two marking elements are disposed in the first sublayer, and the second sublayer is configured to dispose a plurality of calibration holes.

18. A laser drilling calibration system, comprising:
a laser source for emitting a laser beam;
a beam adjustment unit for adjusting a direction of the laser beam; and
a control module connected to the laser source and the beam adjustment unit, wherein the control module is configured to:
control the laser beam to form a plurality of calibration holes on a calibration piece according to a calibration pattern, wherein the calibration pattern comprises predetermined positions of the plurality of calibration holes, the predetermined positions of the plurality of calibration holes are disposed along a first direction and are spaced apart by a multiple of a first predetermined pitch, and are disposed along a second direction and are spaced apart by a multiple of a second predetermined pitch;
select a first standard pitch and a second standard pitch on the calibration piece; and
calculate an offset of at least one of the plurality of calibration holes according to the first standard pitch and the second standard pitch.

19. The laser drilling calibration system of claim 18, wherein the control module is further configured to:
calibrate a design pattern according to the offset to obtain a calibrated design pattern.

20. The laser drilling calibration system of claim 18, wherein the beam adjustment unit is a galvanometer-based laser scanner.
